(19) United States
(12) Patent Application Publication
(10) Pub. No.: US 2024/0072460 A1
(43) Pub. Date: Feb. 29, 2024

(54) CABLE CONNECTOR HAVING PIN TRIM MARKINGS STRUCTURALLY CONFIGURED TO INDICATE PREDETERMINED CUT LOCATIONS SO AS TO PROVIDE CONSISTENT RADIO FREQUENCY PERFORMANCE

(71) Applicant: PPC BROADBAND, INC., East Syracuse, NY (US)

(72) Inventor: Joshua IVANCIC, Clinton, NY (US)

(73) Assignee: PPC BROADBAND, INC., East Syracuse, NY (US)

(21) Appl. No.: 18/240,683

(22) Filed: Aug. 31, 2023

Related U.S. Application Data
(60) Provisional application No. 63/374,158, filed on Aug. 31, 2022.

(51) Int. Cl. H01R 9/05; H01R 24/40

(52) U.S. Cl. CPC H01R 9/0524; H01R 9/0521; H01R 24/40; H01R 2103/00

(57) ABSTRACT

A cable connector structurally configured to facilitate accurate trimming of a connector conductor of the connector to provide consistent radio frequency performance of the connector, including: a connector portion structurally configured to connect to an adapter; and a connector conductor structurally configured to extend from the connector portion. The connector conductor comprises a marking; the connector conductor is structurally configured to electrically connect to a conductor of a cable; the connector conductor is structurally configured to be received by the adapter; and the marking is structurally configured to indicate a cut location of the connector conductor so as to provide consistent radio frequency performance of the cable connector when connected to the adapter.

### CROSS-REFERENCE TO RELATED APPLICATION

This application claims the benefit of U.S. Provisional Application No. 63/374,158 filed Aug. 31, 2022, pending, the disclosure of which is hereby incorporated by reference herein in its entirety.

### BACKGROUND

The present invention relates generally to coaxial cable connectors. More particularly, embodiments of the invention relate to coaxial connectors having markings that facilitate precise cutting of a center conductor pin to improve consistency of center pin cutting.

Some coaxial connectors, such as, for example, hardline connectors, have a pin that is mechanically and electrically connected to a center conductor of the coaxial cable to which the connector is connected. In many cases, the pin needs to be trimmed before the connector is connected to an adapter or other termination point. Service providers and other users of coaxial cables are looking to utilize extended frequencies in their systems. Accurate length of the pin of a connector becomes even more critical at higher frequencies. Any variance in the length of the pin can have adverse effects on radio frequency (RF) performance Accurately trimming the pin to the correct length can be a problem for end users/technicians in the field. On some adapters, trim length marks are included on the body of the adapter or are specified as the width of the adapter body. The end user must hold the connector pin up to these adapters and mark with their fingers where they want to trim the pin. If the end user's fingers move while attempting to cut the pin with, for example, pliers, the trim length will not be accurate. Installing a connector with the resultant incorrect pin length may result in performance issues. Further, if the pin is trimmed too short, the entire connector needs to be discarded.

It may be desirable to provide trim identification markings to the pin of hardline connectors to provide the visual markings to the end user indicating a length at which the pin should be cut so as to provide consistent radio frequency performance of the connector when connected to the adapter.

### SUMMARY

The present disclosure provides a marking on a conductor pin of a connector that is structurally configured to indicate a cut location of the connector conductor so as to provide consistent radio frequency performance of the cable connector when connected to an adapter.

Embodiments provide a cable connector that may be structurally configured to facilitate accurate trimming of a connector conductor of the connector to provide consistent radio frequency performance of the connector, including: a connector body portion; an adapter connection portion that may be structurally configured to mechanically and electrically connect the connector body portion to an adapter; and a connector conductor that may be structurally configured to extend from the adapter connection portion. The connector conductor may include a marking on an outer surface of the connector conductor; the connector body portion may be structurally configured to have an opening; the opening may be structurally configured to receive a cable; the connector body portion may be structurally configured to electrically connect to the adapter connection portion; the connector conductor may be structurally configured to electrically connect to a conductor of the cable; the connector conductor may be structurally configured to be received by the adapter to which the adapter connection portion may be structurally configured to be connected; and the marking may be structurally configured to indicate a cut location of the connector conductor so as to provide consistent radio frequency performance of the cable connector when connected to the adapter.

In particular embodiments, the connector conductor may be a center conductor pin.

In particular embodiments, the cable may be a coaxial cable and the cable connector may be a coaxial cable connector.

In particular embodiments, the connector may further comprise a post located in the connector body portion, the post may be structurally configured to electrically connect to an outer conductor of the cable, and the post may be structurally configured to electrically connect to the connector body portion.

In particular embodiments, the adapter connection portion may be a front nut.

In particular embodiments, the conductor of the cable may be a center conductor of the cable.

In particular embodiments, the connector conductor may be structurally configured to be received by a connector conductor receiving feature of the adapter to which the cable connector is structurally configured to be connected.

In particular embodiments, the adapter may be a first adapter, the marking may be a first marking, a second marking may correspond to a second length of the connector conductor for use with a second adapter, the second adapter may be different from the first adapter, and the second length may be different from a first length for use with the first adapter.

In particular embodiments, the marking may be laser etched into the connector conductor.

Embodiments provide a cable connector that may be structurally configured to facilitate accurate trimming of a connector conductor of the connector to provide consistent radio frequency performance of the connector, including: a first connector portion; a second connector portion that may be structurally configured to connect the first connector portion to an adapter; and a connector conductor that may be structurally configured to extend from the second connector portion. The connector conductor may comprise a marking on the connector conductor; the first connector portion may be structurally configured to electrically connect to the second connector portion; the connector conductor may be structurally configured to electrically connect to a conductor of a cable; the connector conductor may be structurally configured to be received by the adapter to which the second connector portion may be structurally configured to be connected; and the marking may be structurally configured to indicate a cut location of the connector conductor so as to provide consistent radio frequency performance of the cable connector when connected to the adapter.

In particular embodiments, the connector conductor may comprise a plurality of markings on the connector conductor, and the marking may be one of the plurality of markings.

In particular embodiments, the marking may be on an outer surface of the connector conductor.

In particular embodiments, the first connector portion may be structurally configured to have an opening, and the opening may be structurally configured to receive the cable.

In particular embodiments, the connector conductor may be a center conductor pin.

In particular embodiments, the cable may be a coaxial cable and the cable connector may be a coaxial cable connector.

In particular embodiments, the connector may further comprise a post located in the connector body portion, the post may be structurally configured to electrically connect to an outer conductor of the cable, and the post may be structurally configured to electrically connect to the connector body portion.

In particular embodiments, the second connector portion may be a front nut that may comprise a threaded portion that may be structurally configured to threadedly connect to the adapter.

In particular embodiments, the connector conductor may be structurally configured to be received by a connector conductor receiving feature of the adapter to which the cable connector is structurally configured to be connected.

In particular embodiments, the adapter may be a first adapter, the connector conductor may comprise a second marking that corresponds to a second length of the connector conductor for use with a second adapter, the second adapter may be different from the first adapter, and the second length may be different from a first length for use with the first adapter.

Embodiments provide a cable connector that may be structurally configured to facilitate accurate trimming of a connector conductor of the connector to provide consistent radio frequency performance of the connector, including: a connector portion that may be structurally configured to connect to an adapter; a connector conductor that may be structurally configured to extend from the connector portion. The connector conductor may comprise a marking; the connector conductor may be structurally configured to electrically connect to a conductor of a cable; the connector conductor may be structurally configured to be received by the adapter; and the marking may be structurally configured to indicate a cut location of the connector conductor so as to provide consistent radio frequency performance of the cable connector when connected to the adapter.

In particular embodiments, the connector conductor may comprise a plurality of markings on the connector conductor, and the marking may be one of the plurality of markings.

In particular embodiments, the connector portion may be structurally configured to have an opening, and the opening may be structurally configured to receive the cable.

In particular embodiments, the connector conductor may be a center conductor pin.

In particular embodiments, the adapter may be a first adapter, the connector conductor may comprise a second marking that corresponds to a second length of the connector conductor for use with a second adapter, the second adapter may be different from the first adapter, and the second length may be different from a first length for use with the first adapter.

Various aspects of the system, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is a front perspective view of an exemplary connector and adapter in accordance with various aspects of the disclosure.

FIG. 2 is a sectional view of the connector and adapter of FIG. 1 in a connected state.

FIG. 3 is a perspective view of the adapter of FIG. 1.

FIG. 4 is a side view of a connector positioned in front of an adapter.

FIG. 5 is a side view of the connector of FIG. 1 positioned in front of the adapter of FIG. 1 prior to cutting the pin.

FIG. 6 is a side view of the connector of FIG. 1 positioned in front of the adapter of FIG. 1 after cutting the pin.

FIG. 7 is a side view of a particular embodiment of the connector of FIG. 1 prior to cutting the pin.

### DETAILED DESCRIPTION OF EMBODIMENTS

Embodiments of the disclosure provide a marking on a conductor pin of a connector that is structurally configured to indicate a cut location of the connector conductor so as to provide consistent radio frequency performance of the cable connector when connected to an adapter.

Embodiments of the disclosure provide a hardline connector with markings on the pin of the connector. In embodiments, the markings are at set distances from the front of the connector and are easily seen. In embodiments, the markings are laser etched on the pin as this does not materially affect the strength of the pin or the electrical/RF performance. In embodiments, the markings are be set at specific lengths of trim that are commonly used for adapters and equipment in the field. In embodiments, an adapter will include a marking (such as, for example, a laser etched marking) on the body of the adapter that tells the end user which pin trim mark should be used for that specific adapter. For example, a particular splice block adapter uses a ½-inch (0.500″) pin trim length which, in embodiments, is the second marking on the pin. Therefore, a laser etch is included on that particular splice block adapter that says “TRIM 2” to tell the end user to trim the connector at line 2.

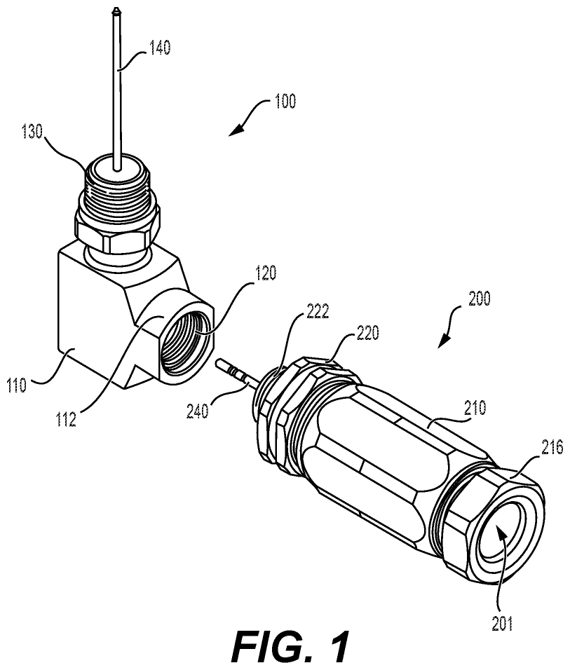

FIG. 1 shows an exemplary connector, for example, a cable connector or coaxial cable connector, 200 and adapter 100 in accordance with embodiments of the disclosure. Adapter 100 has, in this example, a main body 110 including a connection portion 112. Connection portion 112 has internal threads 120 that are configured to receive external threads 222 of connector 200. Adapter 100 also has external threads 130 that are configured to engage internal threads on a terminal point or other device to which adapter 100 is connected. In this example, adapter 100 has a pin 140 that extends from main body 110 and is configured to be received by the terminal point or other device to which adapter 100 is connected.

Connector 200 has a connector portion, for example, a first connector portion, connector body portion, or main body 210 into which a second connector portion, for example, an adapter connection portion or back nut 216 is threaded. On an end of main body 210 opposite the end to which back nut 216 is attached, a third connector portion, for example, a front nut 220 is threaded onto main body 210. As described above, front nut 220 has external threads 222 that are configured to be received by internal threads 120 of adapter 100. Connector 200 has a connector conductor, for example, a pin 240 that extends into, and connects electrically and mechanically to, adapter 100.

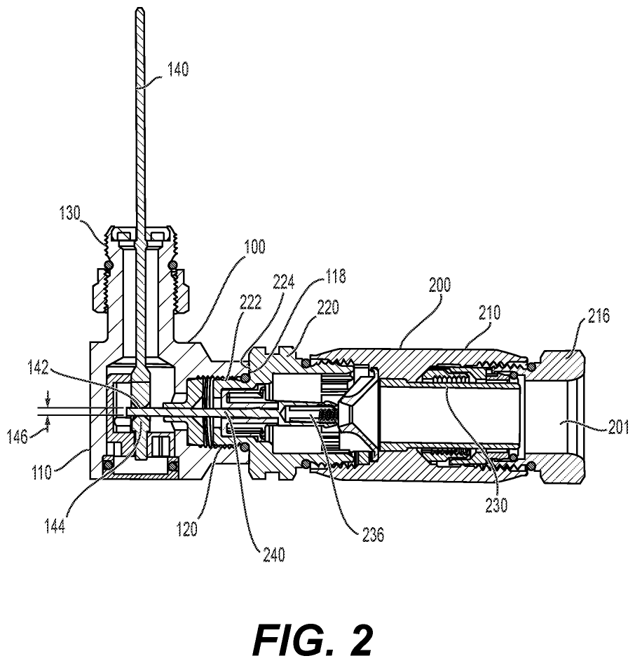

FIG. 2 shows adapter 100 connected to connector 200 by way of threads 222 engaging threads 120. FIG. 2 shows an opening 210 through which a coaxial cable enters connector 200. A post 230 is positioned to receive the coaxial cable and create an electrical connection between an outer (for example, ground) conductor in the coaxial cable and the main body 210 of connector 200. In embodiments, an electrical ground path is formed from the outer conductor of the coaxial cable, through post 203, main body 210, front nut 220, connection portion 112, main body 110, and threads 130, to the terminal point or other device to which adapter 100 is connected. Connector 200 has, in this example, a center conductor receiving portion 236 which is configured to receive a center conductor of the coaxial cable. Center conductor receiving portion 236 is electrically connected to pin 240 of connector 200 to form an electrically conductive path from the center conductor of the coaxial cable to pin 240.

Adapted 100 has, in this example, a first pin contact 142 and a second pin contract 144 that are configured to form a mechanical and electrical contact with pin 240 of connector 200. In embodiments, a space 146 between first pin contact 142 and second pin contact 144 is configured to be slightly less than a thickness of pin 240 such that pin 240 forms an interference fit with first pin contact 142 and second pin contact 144. In embodiments, one or more springs or other urging devices press one or both of first pin contact 142 and second pin contact 144 into secure contact with pin 240. In the position shown in FIG. 2, an electrically conductive path is formed from the center conductor of the coaxial cable through center conductor receiving portion 236, pin 240, first pin contact 142, and pin 140 to the terminal point or other device to which adapter 100 is connected. In the example shown in FIG. 2, a front face 224 of front nut 220 contacts an end face 118 of connection portion 112. In embodiments, the contact between front face 224 of front nut 220 and end face 118 of connection portion 112 is part of the electrical ground path described above.

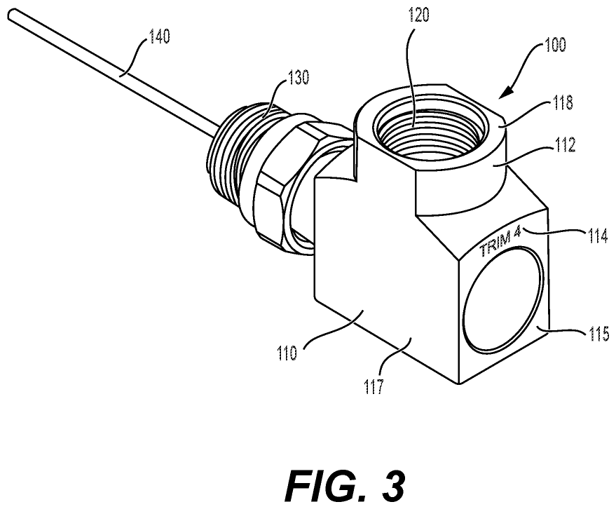

FIG. 3 shows an embodiment of adapter 100 that includes a trim marking 114 that indicates the correct trim length of pin 240 for use with adapter 100. In this example, trim marking 114 indicates that trim length “4” is the correct pin length for use with adapter 100. Embodiments of adapter 100 that require a different trim length of pin 240 will be marked with a different trim marking 114 such as, for example, “1”, “2”, “3”, etc., that indicates a different trim length of pin 240. The trim marking 114 indicates an optimal length of pin 240 so as to reduced adverse effects on radio frequency performance of cable connector 200 when connected to adapter 100.

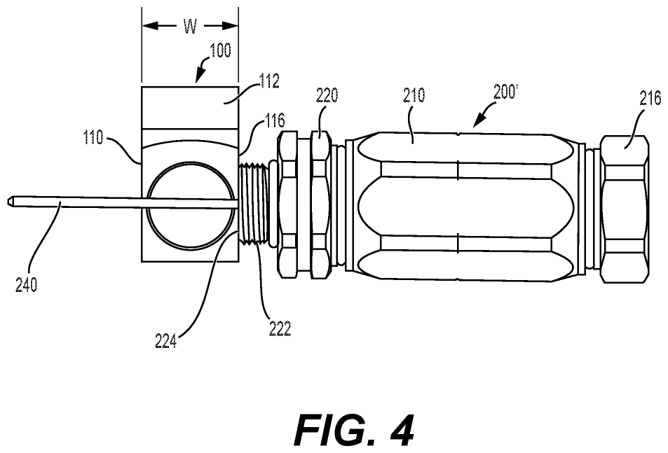

FIG. 4 shows an example of a method of determining the correct trim length of pin 240 without the advantages of embodiments of the invention. FIG. 4 depicts a method in which an end user holds adapter 100 against front face 224 of adapter 200′ and uses the width W of main body 110 to determine the correct length to which pin 240 should be trimmed. As described above, in this method, the end user uses their fingers to indicate the correct trim point and then cuts pin 240 using pliers or some other tool at the indicated trim point. A problem with this method is that the end user's fingers can move between when the user positions them on pin 240 to indicate the trim point and when the end user cuts pin 240. Such movement results in an incorrect pin length.

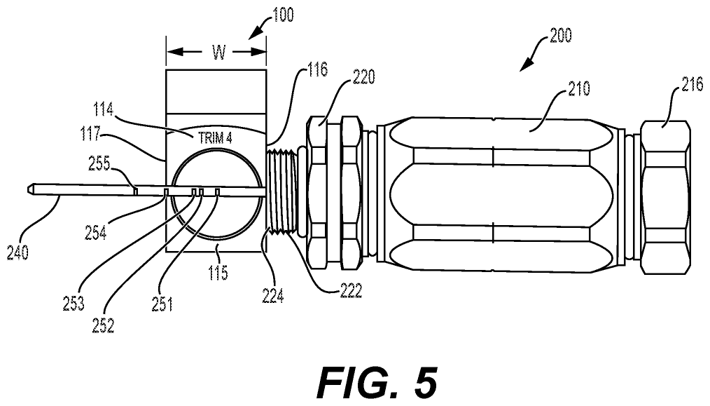

FIG. 5 shows connector 200 having (in this case) five marks, for example, markings or trim marks on pin 240 that each indicate a trim point for a particular length of pin 240. In this example, trim mark 251 indicates a shortest trim length of the indicated trim lengths, trim mark 255 indicates a longest trim length of the indicated trim lengths, and trim marks 252, 253, 254 indicate intermediate trim lengths. In FIG. 5, front face 224 of connector 200 is held in contact with side 116 of main body 110 of adapter 100 so that pin 240 extends across an end face 115 of adapter 100. This positioning shows that trim mark 254 (the fourth trim mark on pin 240) aligns with side 117 of main body 120, indicating that cutting pin 240 at trim mark 254 will result in pin 240 having a length equal to the width W of main body 110. Note also that trim marking 114 indicates that pin 240 should be cut at the fourth trim mark (which is trim mark 254). Unlike connectors that do not have trim marks 251, 252, 253, 254, 255, connector 200 can be trimmed to the proper length without the end user having to user their fingers or some other method to temporarily indicate the proper place to trim pin 240. Connector 200 is shown in the position shown in FIG. 5 simply to show that trim marks 251, 252, 253, 254, 255 correspond to lengths that are commonly required for common adapters, for example, a first adapter and a second adapter that is different from the first adapter. In use, an end user does not need to hold connector 200 in the position shown in FIG. 5 to determine the proper length of pin 240 for a particular adapter. An end user simply needs to read the proper trim length from trim marking 114 (in this example, trim length 4) and then cut pin 240 at the corresponding trim mark (in this example, trim mark 254).

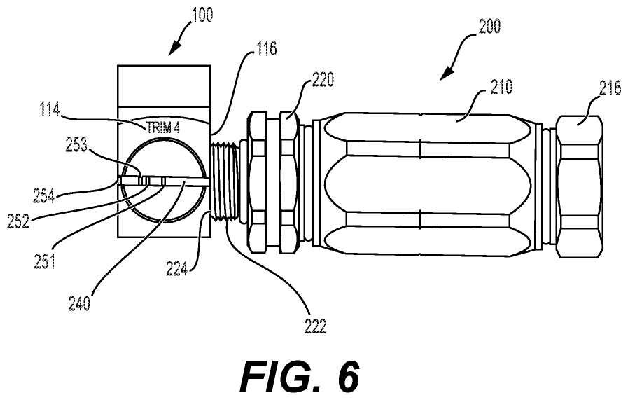

FIG. 6 shows connector 200 after pin 240 has been trimmed to the proper length (at trim mark 254) for this adapter 100. After trimming pin 240 to the appropriate length, the end user threads connector 200 onto adapter 100 as pin 240 is inserted between first pin contact 142 and second pin contact 144 of adapter 100. As a result, pin 240 is cut to the optimal length for this particular adapter 100 in an accurate and repeatable manner.

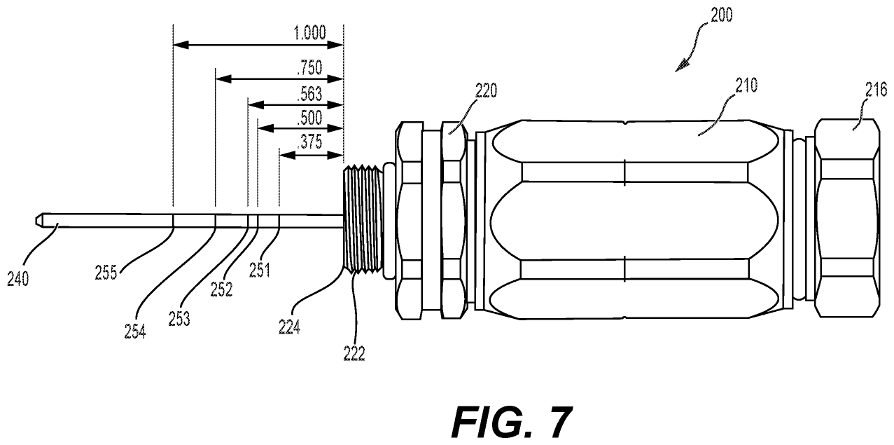

FIG. 7 shows an example of connector 200 where trim mark 251 is positioned to result in pin 240 being trimmed to a length of 0.375″. In this example, trim mark 252 is positioned to result in pin 240 being trimmed to a length of 0.500″. In this example, trim mark 253 is positioned to result in pin 240 being trimmed to a length of 0.563″. In this example, trim mark 254 is positioned to result in pin 240 being trimmed to a length of 0.750″. In this example, trim mark 255 is positioned to result in pin 240 being trimmed to a length of 1.000″. Embodiments include trim marks indicating other trim lengths such as, for example, 1 1/16 inches. The positions of trim marks 251, 252, 253, 254, 255 shown in FIG. 7 correspond to commonly used lengths of pin 240. In other embodiments, pin 240 has fewer or more trim marks. In other embodiments, pin 240 has some or all of the trim marks in different locations than those shown in FIG. 17.

As stated above, in some embodiments, trim marks 251, 252, 253, 254, 255 are laser etched into pin 240. In other embodiments, trim marks 251, 252, 253, 254, 255 are applied to, or otherwise created in, pin 240. For example, in embodiments, trim marks 251, 252, 253, 254, 255 are painted onto pin 240, mechanically etched into pin 240, or otherwise marked on pin 240.

The above describes particular examples of embodiments of the disclosure that provide the benefit of simple, repeatable, and accurate trimming of a pin of a coaxial cable connector. This simple, repeatable, and accurate trimming results in the reduction of adverse effects on RF performance that can result from trimming the pin to an incorrect or non-optimal length.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. A cable connector structurally configured to facilitate accurate trimming of a connector conductor of the connector to provide consistent radio frequency performance of the connector, comprising:
a connector body portion;
an adapter connection portion structurally configured to mechanically and electrically connect the connector body portion to an adapter;
a connector conductor structurally configured to extend from the adapter connection portion;
wherein the connector conductor includes a marking on an outer surface of the connector conductor;
wherein the connector body portion is structurally configured to have an opening;
wherein the opening is structurally configured to receive a cable;
wherein the connector body portion is structurally configured to electrically connect to the adapter connection portion;
wherein the connector conductor is structurally configured to electrically connect to a conductor of the cable;
wherein the connector conductor is structurally configured to be received by the adapter to which the adapter connection portion is structurally configured to be connected; and
wherein the marking is structurally configured to indicate a cut location of the connector conductor so as to provide consistent radio frequency performance of the cable connector when connected to the adapter.

2. The cable connector of claim 1, wherein the connector conductor is a center conductor pin.

3. The cable connector of claim 1, wherein the cable is a coaxial cable and the cable connector is a coaxial cable connector.

4. The cable connector of claim 1, wherein the connector further comprises a post located in the connector body portion, the post is structurally configured to electrically connect to an outer conductor of the cable, and the post is structurally configured to electrically connect to the connector body portion.

5. The cable connector of claim 1, wherein the adapter connection portion is a front nut.

6. The cable connector of claim 1, wherein the conductor of the cable is a center conductor of the cable.

7. The cable connector of claim 1, wherein the connector conductor is structurally configured to be received by a connector conductor receiving feature of the adapter to which the cable connector is structurally configured to be connected.

8. The cable connector of claim 1, wherein the adapter is a first adapter, the marking is a first marking, a second marking corresponds to a second length of the connector conductor for use with a second adapter, the second adapter is different from the first adapter, and the second length is different from a first length for use with the first adapter.

9. The cable connector of claim 1, wherein the marking is laser etched into the connector conductor.

10. A cable connector structurally configured to facilitate accurate trimming of a connector conductor of the connector to provide consistent radio frequency performance of the connector, comprising:
a first connector portion;
a second connector portion structurally configured to connect the first connector portion to an adapter;
a connector conductor structurally configured to extend from the second connector portion;
wherein the connector conductor comprises a marking on the connector conductor;
wherein the first connector portion is structurally configured to electrically connect to the second connector portion;
wherein the connector conductor is structurally configured to electrically connect to a conductor of a cable;
wherein the connector conductor is structurally configured to be received by the adapter to which the second connector portion is structurally configured to be connected; and
wherein the marking is structurally configured to indicate a cut location of the connector conductor so as to provide consistent radio frequency performance of the cable connector when connected to the adapter.

11. The cable connector of claim 10, wherein the connector conductor comprises a plurality of markings on the connector conductor, and the marking is one of the plurality of markings.

12. The cable connector of claim 10, wherein the marking is on an outer surface of the connector conductor.

13. The cable connector of claim 10, wherein the first connector portion is structurally configured to have an opening, and the opening is structurally configured to receive the cable.

14. The cable connector of claim 10, wherein the connector conductor is a center conductor pin.

15. The cable connector of claim 10, wherein the cable is a coaxial cable and the cable connector is a coaxial cable connector.

16. The cable connector of claim 10 wherein the connector further comprises a post located in the connector body portion, the post is structurally configured to electrically connect to an outer conductor of the cable, and the post is structurally configured to electrically connect to the connector body portion.

17. The cable connector of claim 10, wherein the second connector portion is a front nut that comprises a threaded portion that is structurally configured to threadedly connect to the adapter.

18. The cable connector of claim 10, wherein the connector conductor is structurally configured to be received by a connector conductor receiving feature of the adapter to which the cable connector is structurally configured to be connected.

19. The cable connector of claim 10, wherein the adapter is a first adapter, the connector conductor comprises a second marking that corresponds to a second length of the connector conductor for use with a second adapter, the second adapter is different from the first adapter, and the second length is different from a first length for use with the first adapter.

20. A cable connector structurally configured to facilitate accurate trimming of a connector conductor of the connector to provide consistent radio frequency performance of the connector, comprising:
a connector portion structurally configured to connect to an adapter;
a connector conductor structurally configured to extend from the connector portion;
wherein the connector conductor comprises a marking;
wherein the connector conductor is structurally configured to electrically connect to a conductor of a cable;
wherein the connector conductor is structurally configured to be received by the adapter; and
wherein the marking is structurally configured to indicate a cut location of the connector conductor so as to provide consistent radio frequency performance of the cable connector when connected to the adapter.

21. The cable connector of claim 20, wherein the connector conductor comprises a plurality of markings on the connector conductor, and the marking is one of the plurality of markings.

22. The cable connector of claim 20, wherein the connector portion is structurally configured to have an opening, and the opening is structurally configured to receive the cable.

23. The cable connector of claim 20, wherein the connector conductor is a center conductor pin.

24. The cable connector of claim 20, wherein the adapter is a first adapter, the connector conductor comprises a second marking that corresponds to a second length of the connector conductor for use with a second adapter, the second adapter is different from the first adapter, and the second length is different from a first length for use with the first adapter.
